(19) United States
(12) Patent Application Publication
(10) Pub. No.: US 2015/0363751 A1
(43) Pub. Date: Dec. 17, 2015

(54) Methods For Matchmaking

(71) Applicant: Nicholas F. Covello, III, CHICAGO, IL (US)

(72) Inventor: Nicholas F. Covello, III, CHICAGO, IL (US)

(21) Appl. No.: 14/301,933

(22) Filed: Jun. 11, 2014

(51) Int. Cl. G06Q 20/08; G06Q 10/02; G06F 17/30

(52) U.S. Cl. CPC G06Q 20/0855; G06F 17/30412; G06F 17/30873; G06Q 10/02; G06Q 50/01

(57) ABSTRACT

A method is provided for matching a plurality of users of a matchmaking system. The method has a step of providing a matchmaking system with a collection portal for collecting characteristic information from a first and second user of the system. The system further has an aggregator in communication with the collection portal. The aggregator is for creating an aggregated database comprising the characteristic information of the first user and the characteristic information of the second user. The method has another step of collecting characteristic information from the first user and the second user through the collection portal. The method has another step of creating an aggregated comprising the characteristic information. The method further has the step of verifying attendance information for at least one of the first and second users at an event. The method has a step of updating the aggregated database based on the attendance information.

### FIELD OF THE INVENTION

This invention relates to a method for matching the users of a matchmaking system, and more particularly, a method of using a matchmaking system for facilitating a meeting between users attending an event.

### BACKGROUND

Matchmaking or dating systems allow users to interact remotely with the potential for facilitating an eventual in-person meeting between the users. The internet has facilitated the growth and proliferation of such matchmaking systems on a variety of platforms to the extent that there are presently many different systems. Each system may be catered to a specific user interest or subpopulation.

Many of these systems possess a sorting mechanism enabling a first user of the system to retrieve characteristic information of a second user of the system based on a particular characteristic of interest of one or both of the users. This characteristic may be, for example, a desired age range, a physical attribute, or a specific trait such as religious affiliation or leisurely pursuit of a user. This sorting mechanism may be a pre-defined algorithm or may be comprised of one or more human matchmakers tasked with matching various users of a system.

Present matchmaking systems may further possess a communication or messaging channel enabling one-way or two-way communication between the users of the system. In this manner, the users may conduct a conversation over an extended period of time. Eventually, the users may choose to meet in person. Such communication may be considered by some users to be undesirably time consuming, because it may span days, weeks, or even months of back-and-forth messaging.

Some prior art references describe improvements upon the sorting and communication methods of prior art matchmaking systems, such as U.S. Patent Application No. US20130080527 published Pummill et al. and U.S. Patent Application No. US20130110731 published to Wey.

It would be desirable for a matchmaking system to enable one or more users of the system to meet at a specific event. Further, it would be desirable for the system to provide a single, convenient platform for facilitating such a meeting. It would additionally be desirable for such a system to be utilized in conjunction with an organizer or promoter of the event.

### SUMMARY OF THE INVENTION

According to one aspect of the present invention, a method is provided for matching a plurality of users of a matchmaking system. The method has a step of providing a matchmaking system. The system has a collection portal for collecting characteristic information from a first and second user of the system. The first and second users are attendees of an event. The system further has an aggregator in communication with the collection portal. The aggregator is for creating an aggregated database comprising the characteristic information of the first user and the characteristic information of the second user. The method has another step of collecting characteristic information from the first user and the second user through the collection portal. The method has another step of creating an aggregated database comprising the characteristic information. The method further has the step of verifying attendance information for at least one of the first and second users at the event. The method has a further step of updating the aggregated database based on the attendance information.

According to another aspect of the present invention, a method is provided for matching a plurality of users of a matchmaking system. The method has a step of providing a matchmaking system. The system has a collection portal for collecting characteristic information from a first and second user of the system. The first and second users are attendees of an event. The system further has an aggregator in communication with the collection portal. The aggregator is for creating an aggregated database comprising the characteristic information of the first user and the characteristic information of the second user. The system further has a display in communication with the aggregated database for displaying the characteristic information of at least one of the first user and second user. The system further has a communication portal in communication with the display for enabling at least one of the first user and the second user to communicate via the system. The method has another step of collecting characteristic information from the first user and the second user through the collection portal. The method has another step of providing to at least one of the first user and second user an access key to the system. The method has another step of creating an aggregated database comprising the characteristic information. The method further has the step of displaying the characteristic information of at least one of the first and second users at the event. The method has a further step of enabling communication from the first user to the second user through the communication portal.

### BRIEF DESCRIPTION OF THE DRAWINGS

FIG. 1 is a diagrammatic view of a matchmaking system for use with a method of matching a plurality of users according to the present invention;

FIG. 2 is a diagrammatic view of a first method of matching a plurality of users of a matchmaking system according to the present invention;

FIG. 3 is a diagrammatic view of alternative methods of matching a plurality of users of a matchmaking system according to the present invention; and

FIG. 4 is a diagrammatic view of another method of matching a plurality of users of a matchmaking system according to the present invention.

### DETAILED DESCRIPTION OF THE PREFERRED EMBODIMENT

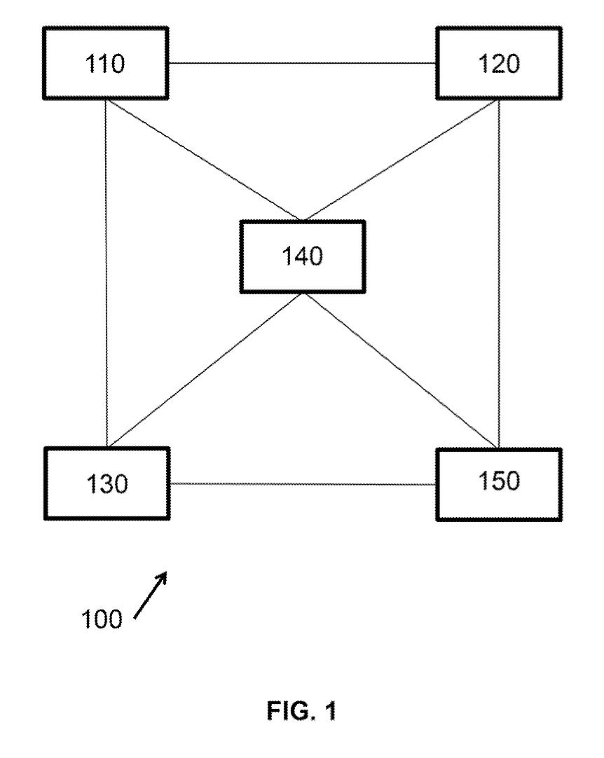

FIG. 1 illustrates a matchmaking system 100 for use with a method of matching a plurality of users according to the present invention. The system has a collection portal 110 for collecting characteristic information from a first user and a second user of the system. The collection portal 110 may be a physical location with a data entry means, such as a video display and a data entry device, located at a kiosk. The kiosk is preferably located at a venue that is hosting an event, and is preferably located at or near a point of sale for a ticket to the event. The event may be any gathering for an audience, such as a concert, sporting match, religious gathering, or other entertainment. Preferably, the event is a unique, one-time occurrence for which an attendee purchases a single-use ticket for admittance. The collection portal 110 may alternatively be a program running on a computer, such as a mobile computer or smart phone. When the collection portal 110 is an application running on a computer, it has data input fields for allowing a user of the system 100 to upload the user's characteristic information into the system 100. The characteristic information may be identifying data of the user, such as the age, sex, or interests of the user. The characteristic information may further be one or more photographs uploaded by the user into the system through the collection portal 110. In one form of the system 100, the characteristic information includes a photograph taken at the venue of the event.

Still referring to FIG. 1, the system 100 has an aggregator 120 in communication with the collection portal 110. The aggregator 120 is for creating an aggregated database comprising the characteristic information of a user that is input into the system 100. The aggregator 120 is a software application running on either a computer of the system provider or a computer of a user of the system. The aggregated database can be located in the memory of the provider's computer or the computer of the provider. When the collection portal 110 is a physical location, the aggregator 120 is in communication with the collection portal 110 via a cellular, wired, or wireless network for transferring the characteristic information from the collection portal 110 to the aggregator 120. When the collection portal 110 is part of a program running on a computer, the collection portal 110 may be in communication with the aggregator 120 as part of a single software application or may be a separate program in communication with the collection portal 110 via a wireless, wired, or cellular network.

Referring to FIG. 1, the system 100 may have a communication portal 130 in communication with one or more of the collection portal 110 and the aggregator 120. The communication portal 130 is for enabling users of the system 100 to communicate with one another. This communication may take the form of a text message or email, a recorded sound or video message, or a real-time video connection between the users. Preferably, the communication portal 130 is part of a program running on a computer, and may be part of a single software application including the collection portal 110 and the aggregator 120. Alternatively, the communication portal 130 may be a display screen and data input means (e.g., keyboard, mouse, camera) at a kiosk at the event venue.

Referring still to FIG. 1, the system 100 may have a sorter 140 in communication with one or more of the collection portal 110 and the aggregator 120. The sorter 140 is for sorting the aggregated database containing the characteristic information of the users of the system 100. The sorting function of the sorter 140 is triggered by an input from a user of the system or an input of a third party matchmaker. The resulting sorted database contains a limited subset of users of the system 100. Preferably, the sorter 140 is part of a program running on a computer, and may be part of a single software application including the collection portal 110 and the aggregator 120. The sorter 140 may take a variety of forms, such as a search field, menu, or buttons containing a variety of characteristics of a user.

The system 100 may further have a payment portal 150 for accepting a payment from one or more of the users of the system 100. The payment portal 150 may be a located at or near the collection portal 110 when the collection portal 110 is a physical location at the event venue. In the alternative, the payment portal 150 may be a payment screen running on an application containing the collection portal 110. Preferably, the payment portal accepts a credit/debit card payment, or funds from an electronic wallet and provides users of the system 100 access to the system 100. In the preferred embodiment of the method for matchmaking (discussed in detail hereinafter), a payment via the payment portal 150 grants a user of the system 100 access to the system 100 for a limited time. This limited time may be a defined time span or may grant access to the system for a finite number of events at one or more venues. The characteristic data of a user for the event may be erased after the finite number of events has been reached, or the time span has run. Preferably, the user's characteristic information is erased after the event.

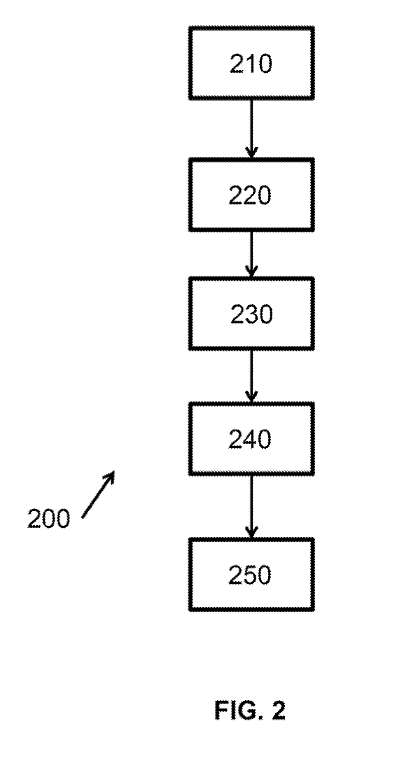

Referring next to FIG. 2, a method for matching a plurality of users of a matchmaking system according to the present invention is illustrated. The method has a first step 210 of providing a matchmaking system. The matchmaking system has a collection portal for collecting characteristic information from a first user and a second user of the system. The first and second users are attendees of an event at a venue. The system further has an aggregator in communication with the collection portal for creating an aggregated database with the characteristic information of the first user and second users. As discussed above with respect to FIG. 1, the system may be a software application or may be a hybrid of a software application and one or more physical locations or stations located at the venue of the event.

The method has another step 220 of collecting the characteristic information from the first user and the second user through the collection portal of the matchmaking system. This collection step may be accomplished at a physical location at the venue, such as a kiosk, ticket-taking station, or the like. The first or second user may input the characteristic information manually at the venue, or a greeter or an attendant at the venue may input the characteristic information into the system, such as by taking and uploading a photograph or other identifying information from the first and second users. The collection step may be accomplished via a collection portal that is running as a software application on a computer of the first or second users. Therefore, the characteristic information may be uploaded or input by the first or second user into the system prior to attending the event. The users may create a profile at his or her leisure, by inputting textual or photographic information via a website or application running on the user's computing device. The user may further be given an access key or website link at the collection portal to enable access to the matchmaking system.

The method has another step 230 of creating an aggregated database comprising the characteristic information from the first user and the second user once the characteristic information has been obtained through the collection portal of the matchmaking system. This aggregated database is compiled by the aggregator of the system and may be stored in a centralized database of the provider of the system or may be stored locally in a computer at the event, or even stored in a user's computer. The aggregated database may comprise characteristic information of the user such as the user's email address or a ghost or truncated email address that is invisible or obscured to other users of the system.

Still referring to FIG. 2, the method has another step 240 of verifying attendance information for at least one of the first and second users attending the event. The verification step of the method may be accomplished at several locations within the event venue, such as at the point of entry into the venue or a kiosk within the venue. The attendance information may be taken by scanning the ticket of a first or second user as the first or second user enters the venue. The attendance information may alternatively be taken if the user checks-in at a kiosk within the event. The check-in may performed by the user or venue attendant actively scanning a barcode on the user's ticket or smart phone. The check-in may alternatively occur automatically by the system correlating the geographical location data (GPS) of the user to that of the venue. In this manner, the users of the system are automatically verified as attending the event when their geographical location data is within a threshold distance of the geographical location of the venue.

Still referring to FIG. 2, the method has another step 250 of updating the aggregated database of the system based on the attendance information. Updating the aggregated database with the attendance information may be accomplished by communicating the attendance information to the aggregated database through a cellular, wireless, or wired network or internet connection in communication with the database. If the attendance information is taken at the entry into the venue or a kiosk within the venue, then that entry location or kiosk would be connected to the system via the network connection. The attendance information may alternatively be taken an application on a user's smart phone running the matchmaking system as a software application. If the attendance information is taken by correlating the geographical location data of the user to that of the venue, then the user's smart phone will transmit the attendance information via the application running on the smart phone.

The method 200 illustrated in FIG. 2 thus enables a matchmaking system to be used in conjunction with a specific event, such as a one-time sporting event. Some users of prior art matchmaking systems may not have the time or desire to create a lengthy profile, which requires the user to input an ample amount of characteristic information. Such users may also not wish to engage in a prolonged back and forth communication with others. Further, some users may wish to be matched with other enthusiasts or attendees of a specific event. Therefore, the illustrated system may offer a seamless matchmaking option with a minimal amount of requisite user characteristic information that must be entered into the system. Because the system is used with at least one specific event, maintaining attendance information is important for providing accurate information to users of the system, which in turn will facilitate an in-person meeting at the event venue.

The event may be hosted or organized by an unaffiliated third party, the unaffiliated third party being unaffiliated with a provider of the matchmaking system. When the event organizer is an unaffiliated third party, the attendance information may be taken via: a user updating the aggregated database while running the matchmaking system application on a mobile device; updating the aggregated database automatically by transmission of the user's geographic location data to the system; or updating (either manually or automatically) the aggregated database when the user interacts with or approaches a kiosk at the event.

Alternatively, the event may be hosted or organized by an affiliated third party, whereby the provider of the matchmaker system provides a payment to the affiliated third party for the use or deployment of the system in at the event. When the event organizer is an affiliated third party, the attendance information may be taken as discussed above with respect to an unaffiliated third party. Additionally, the attendance information may be taken via: scanning a user's ticket or cell phone or other readable storage device at the entrance to the event to update the aggregated database; or the affiliated third party may take the attendance information of the user at another location proximate the venue.

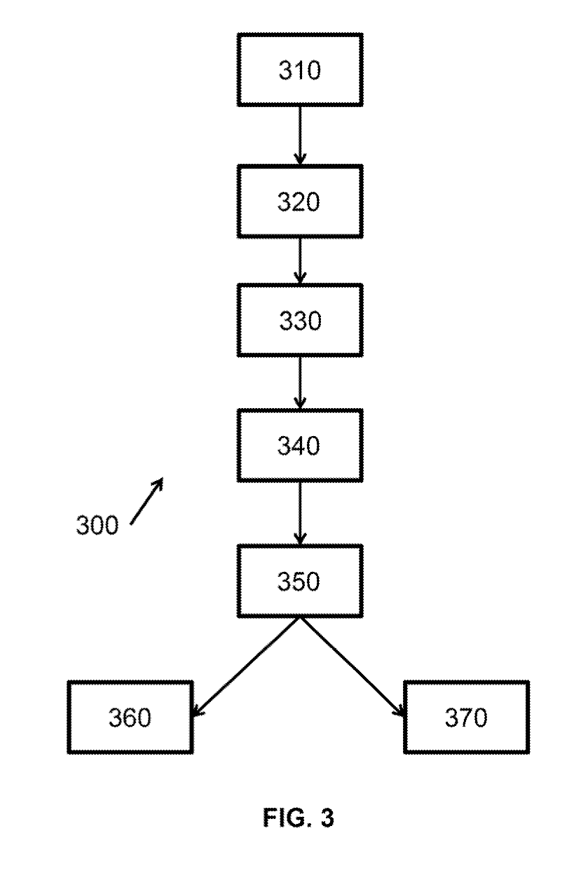

Referring next FIG. 3, two alternative methods are illustrated generally as reference 300. Steps 310, 320, 330, 340, and 350 are identical to aforementioned steps 210, 220, 230, 240, and 250, respectively. The first form of method 300 has an additional step 360 of sorting the aggregated database based the attendance information of a user of the system.

Alternatively, method 300 may have an additional step 370 of accepting a payment from the user of the system via a payment portal. The payment portal, as discussed earlier, may be a payment screen displayed on the computing device of the user or may be a physical location at the venue of the event.

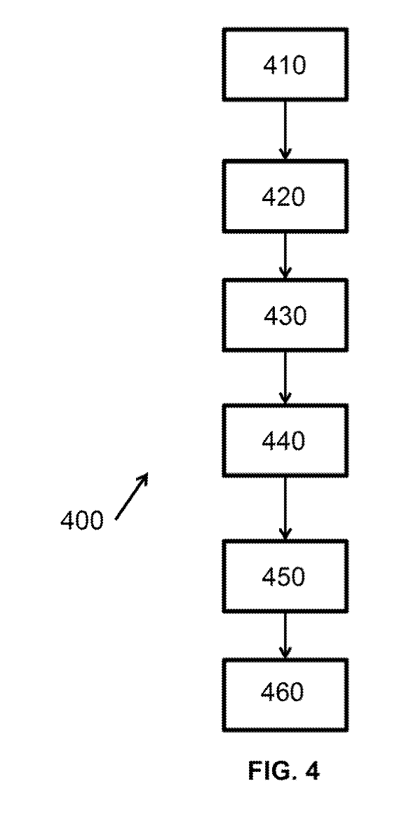

Referring to FIG. 4, a method 400 for matching a plurality of users of a matchmaking system according to the present invention is illustrated. The method has a first step 410 of providing a matchmaking system. The matchmaking system has a collection portal for collecting characteristic information from a first user and a second user of the system. The first and second users are attendees of an event at a venue. The system further has an aggregator in communication with the collection portal for creating an aggregated database with the characteristic information of the first user and second users. The system further has a display in communication with the aggregated database for displaying the characteristic information the first user and second user. The display may be a computer screen, monitor, or portable electronic display on a user's smart phone. The system has a communication portal in communication with the display for enabling the first user and said second user to communicate via the system. The communication portal may be a message window running on an application of the system. Preferably, the characteristic information can be displayed on the system display and a link is provided to the communication portal. By interacting with the first user's characteristic information, the second user may subsequently send a message or communication to the first user. As discussed above with respect to FIG. 1, the system may be a software application or may be a hybrid of a software application and one or more physical locations or stations located at the venue of the event.

The method 400 has another step 420 of collecting the characteristic information from the first user and the second user through the collection portal of the matchmaking system. This collection step may be accomplished at a physical location at the venue, such as a kiosk, ticket-taking station, or the like. The first or second user may input the characteristic information manually at the venue, or a greeter or an attendant at the venue may input the characteristic information into the system, such as by taking and uploading a photograph or other identifying information from the first and second users. The collection step may be accomplished via a collection portal that is running as a software application on a computer of the first or second users. Therefore, the characteristic information may be uploaded or input by the first or second user into the system prior to attending the event. The users may create a profile at his or her leisure, by inputting textual or photographic information via a website or application running on the user's computing device.

The method has another step 430 of providing one or both of the first or second user access to the system. Access to the system may be accomplished by sending the users a link or key to the system. This key may be a physical code handed to the users to be entered into a website portal for the matchmaking system or the key may be a sent to the users electronically via email.

The method has another step 440 of creating an aggregated database comprising the characteristic information from the first user and the second user once the characteristic information has been obtained through the collection portal of the matchmaking system. This aggregated database is compiled by the aggregator of the system and may be stored in a centralized database of the provider of the system or may be stored locally in a computer at the event, or even stored in a user's computer. The aggregated database may comprise characteristic information of the user such as the user's email address or a ghost or truncated email address that is invisible or obscured to other users of the system.

Still referring to FIG. 4, the method has another step 450 of displaying the characteristic information of at least one of the first and second users at the event. The display step 450 of the method may be accomplished at several locations within the event venue, such as at the point of entry into the venue or a kiosk within the venue. Alternatively, the display step 450 may performed on either user's smart phone or web browser. The characteristic information of one or both users may be displayed in a number of aesthetic manners, such that the users may quickly and conveniently review the characteristic information, which may be a profile picture or text.

Still referring to FIG. 4, the method has another step 460 of enabling communication from the first user to the second user through said communication portal. Communication may be accomplished by providing a link to a communication window or screen where text or photos may be sent between the first and second users of the system. The link is preferably attached to the photograph of each user, whereby selecting or interacting with the photograph invokes the communication window.

The method 400 illustrated in FIG. 4 also enables a matchmaking system to be used in conjunction with a specific event, such as a one-time sporting event. Some users of prior art matchmaking systems may not have the time or desire to create a lengthy profile, which requires the user to input an ample amount of characteristic information. Such users may also not wish to engage in a prolonged back and forth communication with others. Further, some users may wish to be matched with other enthusiasts or attendees of a specific event. Therefore, the illustrated system may offer a seamless matchmaking option with a minimal amount of requisite user characteristic information that must be entered into the system. An efficient way to coordinate the use of the system at the event is to provide a limited-use access key to one or more of the users at the event.

The foregoing disclosure of specific embodiments is intended to be illustrative of the broad concepts comprehended by the invention.

1. A method for matching a plurality of users of a matchmaking system, said method comprising the steps of:
a. providing a matchmaking system, said matchmaking system having
i. a collection portal for collecting characteristic information from a first user and a second user of said system, said first and second users being attendees of an event,
ii. an aggregator in communication with said collection portal, said aggregator for creating an aggregated data base comprising said characteristic information of said first user and said characteristic information of said second user,
b. collecting characteristic information from said first user and said second user through said collection portal;
c. creating an aggregated database comprising said characteristic information;
d. verifying attendance information for at least one of said first and second users at said event; and
e. updating said aggregated database based on said attendance information.

2. The method of claim 1 wherein said event is organized by an unaffiliated third party, wherein said unaffiliated third party is unaffiliated with a provider of said system.

3. The method of claim 1 wherein said event is organized by an affiliated third party, wherein a provider of said system provides a payment to said affiliated third party for use of said system in conjunction with said event.

4. The method of claim 1 wherein said attendance information is verified by a geographical location signal of at least one of said first and second users proximal a venue of said event.

5. The method of claim 1 wherein said collection portal is a data entry means located at a kiosk, wherein said kiosk is located at a venue of said event.

6. The method of claim 1 wherein at least one of said collection portal and said communication portal is an application running on a computer.

7. The method of claim 6 wherein said computer is a mobile computer.

8. The method of claim 1 wherein said collection portal is a physical point of sale located at a venue for said event.

9. The method of claim 1 wherein said system further comprises a communication portal, said communication portal for enabling said first user to communicate with said second user.

10. The method of claim 9 further comprising the step of providing video communication between said first and second users through said communication portal.

11. The method of claim 9 wherein said collection portal, said aggregator, and said communication portal comprise a single application running on a computer.

12. The method of claim 1 wherein said characteristic information of at least one of said first and second users is erased after the conclusion of said event.

13. The method of claim 1 wherein said collection portal is customized for said event.

14. The method of claim 1 wherein said characteristic information includes a photograph of said first user.

15. The method of claim 1 wherein said system further comprises a sorter in communication with said aggregator, said sorter for sorting said aggregated database based on an input from at least one of (1) said first user, (2) said second user, and (3) a third-party matchmaker.

16. The method of claim 15 wherein said third-party matchmaker is a pre-defined algorithm.

17. The method of claim 15 further comprising the step of sorting said aggregated database with said sorter based on said attendance information.

18. The method of claim 1 wherein said system further comprises a payment portal, said payment portal for accepting a payment from at least one of said first and second users of said system.

19. The method of claim 18 wherein said payment provides said first user to view said characteristic information of said second user for a limited duration.

20. A method for matching a plurality of users of a matchmaking system, said method comprising the steps of:
a. providing a matchmaking system, said matchmaking system having
i. a collection portal for collecting characteristic information from a first user and a second user of said system, said first and second users being attendees of an event,
ii. an aggregator in communication with said collection portal, said aggregator for creating an aggregated data base comprising said characteristic information of said first user and said characteristic information of said second user,
iii. a display in communication with said aggregated database for displaying said characteristic information of at least one of said first user and second user,
iv. a communication portal in communication with said display for enabling at least one of said first user and said second user to communicate via said system,
b. collecting characteristic information from said first user and said second user through said collection portal;
c. providing to at least one of said first user and second user an access key to said system;
d. creating an aggregated database comprising said characteristic information;
e. displaying said characteristic information of at least one of said first and second users at said event; and
f. enabling communication from said first user to said second user through said communication portal.
